(19) United States
(12) Patent Application Publication
(10) Pub. No.: US 2011/0173529 A1
(43) Pub. Date: Jul. 14, 2011

(54) TEMPLATE PROCESSING ENGINE FOR BUSINESS SYSTEMS

(75) Inventor: Robert J. Wagner, Fargo, ND (US)

(73) Assignee: Microsoft Corporation, Redmond, WA (US)

(21) Appl. No.: 12/685,183

(22) Filed: Jan. 11, 2010

(51) Int. Cl. G06F 17/00

(52) U.S. Cl. 715/235

(57) ABSTRACT

A template processing engine is used for generating and/or modifying reports in business systems. The template processing engine receives predefined templates and structured data from the business system, enables a user to select a template, clones appropriate template rows or columns, and adds them to an output report. The output report may be displayed to the requesting user, printed, emailed, or stored based on user request or default parameters.

### BACKGROUND

Business solution applications provide a large number of powerful tools addressing many aspects of businesses and other organizations. A majority of such applications provide integrated capabilities for financial management, distribution, manufacturing, project accounting, human resource management, field service management, business analytics, and comparable areas. An important aspect of these applications is providing automated business accounting functions.

Automated business functions include, among other things, creation of various reports. Reports may include quotes, invoices, sales analyses, inventory analyses, orders, and comparable ones. A wide range of data is collected by business systems, which may be used in different formats for generating these reports. A common characteristic of reports is they contain unique portions of text and graphics in each one supplemented by data retrieved from a data source. Users may wish to customize both portions of the reports. While the unique portions are typically customized once and can be save/used as templates, the repeated data portions are more difficult to customize each time a report is generated or modified.

Various applications such as word processing applications, spreadsheet applications, or presentation applications may be used to generate the reports. While template documents for generating reports and similar files exist, customizing those and automatically importing data into the templates in a customized fashion is a challenge that may degrade user experience for business solution applications.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to template processing for generating reports in business systems. A template processing engine according to embodiments may receive predefined templates and structured data from the business system, clone appropriate template rows or columns, and add them to an output report.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram of a business system where a template processing engine according to embodiments may be implemented;

FIG. 2 is a block diagram illustrating generation of a report by a template processing engine;

FIG. 3 is a block diagram illustrating different components of a template processing engine according to embodiments in generating combination documents;

FIG. 4 is a screenshot of an example user interface for generating/modifying report templates;

FIG. 5 is an example quote document with tags indicating different data segments that may be used by a template processing engine according to embodiments;

FIG. 6 is the example quote document of FIG. 5 after it has been processed by the template processing engine;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of generating reports using a template processing engine according to embodiments.

### DETAILED DESCRIPTION

As briefly described above, a template processing engine may be employed to generate and modify customized reports in a business system in an efficient and user friendly manner. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing business systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

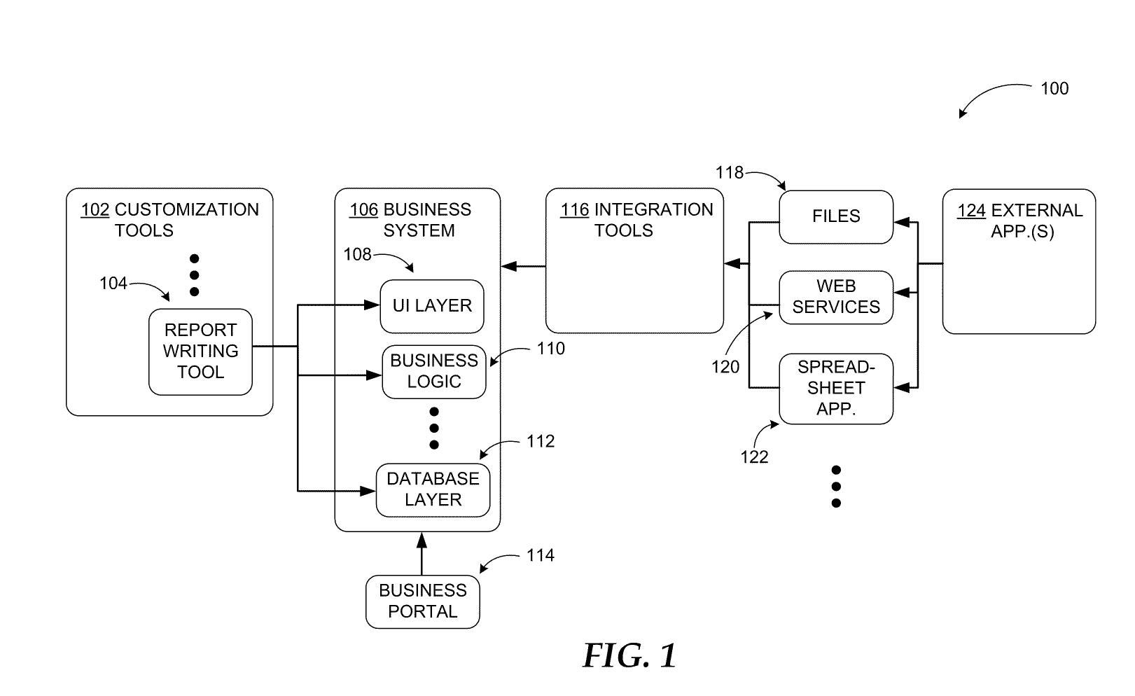

FIG. 1 illustrates diagram 100 of a business system and associated tools where a template processing engine according to embodiments may be implemented. A business system such as the one shown in diagram 100 may provide solutions in financial management, analytics, human resource management, customer relationship management, field service management, supply chain management, manufacturing, retail management, foundation, customization tools, project management, business portal, and comparable areas.

The business system may comprise a variety of business processes divided into modules, which are collections of applications that work together to meet a number of related accounting and business management goals. Modules with similar purposes may be organized into solution series such as the ones described above.

In diagram 100, three example layers of architecture are illustrated in business system block 106. These include user interface layer 108, business logic layer 110, and database layer 112. Database layer 112 provides database-level integration enabling direct access to the data. Business logic layer 110 ensures valid data and performance through integration. User interface layer 108 enables manual and automated data entry such as retrieval from various data stores (e.g. relational databases, tables, other forms of structured data) through business portal 114. Although not shown, a data dictionary layer may contain the resources for defining and creating the data models such as resources for foundational and financial components. The data dictionary layer is an example of additional layers that may be included in business system 106.

User interface layer 108, business logic layer 110, database layer 112, and other layers of business system 106 architecture may be customized through customization tools 102. One example of customization tools 102 is report writing tool 104. Report writing tool 104 enables generation and modification of custom reports that may be generated using the defined processes and data associated with business system 100. Integration tools 116 enable transfer of data from one source to another such as files 118 (e.g. documents), web services 120, spreadsheet applications 122, and the like. External application(s) 124 may also be used in conjunction with business system 106.

Employing customization tools 102 (e.g. report writing tool 104) applications, user interfaces, templates, and documents may be modified/generated to meet the specific needs of an industry, vertical market, or individual end-user. Customization of templates (e.g. report templates) may include rearranging of fields, addition or removal of fields, modifying properties of fields, modifying/adding/removing labels, and comparable tasks.

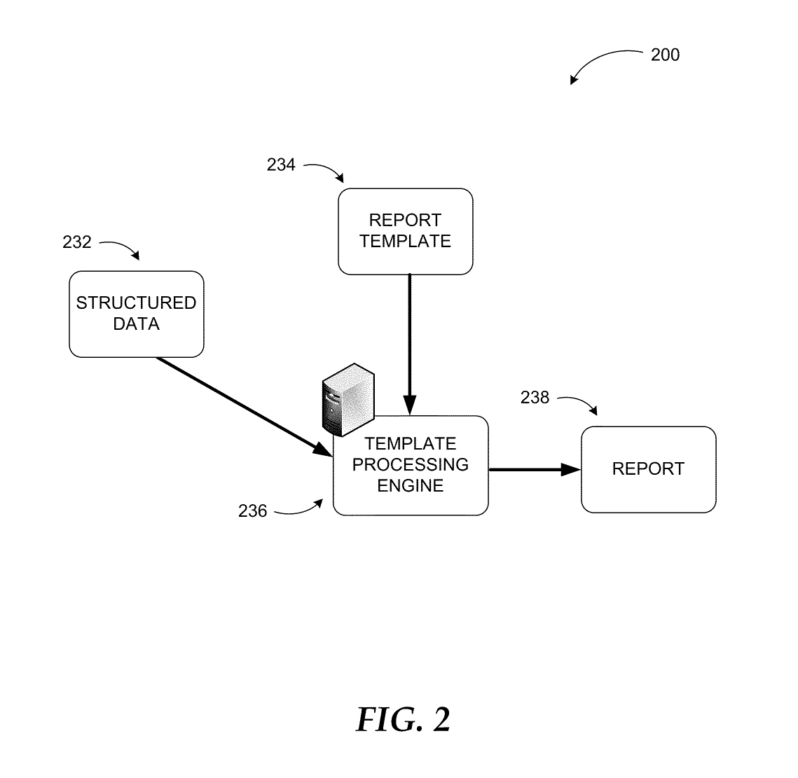

FIG. 2 illustrates block diagram 200 for generation of a report by a template processing engine. As mentioned previously, reports may include quotes, invoices, sales analyses, inventory analyses, orders, and comparable ones. In a system according to embodiments, template processing engine 236 receives report template 234 and structured data 232 at runtime and automatically integrates the data into the report template while customizing as needed. The output report 238 may be a word processing document, a spreadsheet document, a presentation document, or in another format. The report may be stored, printed, or otherwise provided as requested by the user.

Template processing engine 236 may be implemented as a module of a report writing application, as a separate application, or as a centralized/distributed service. Template processing engine 236 may operate through its own user interface or through the user interface of the underlying business system. Furthermore, template processing engine 236 may include one or more modules of its own for various tasks.

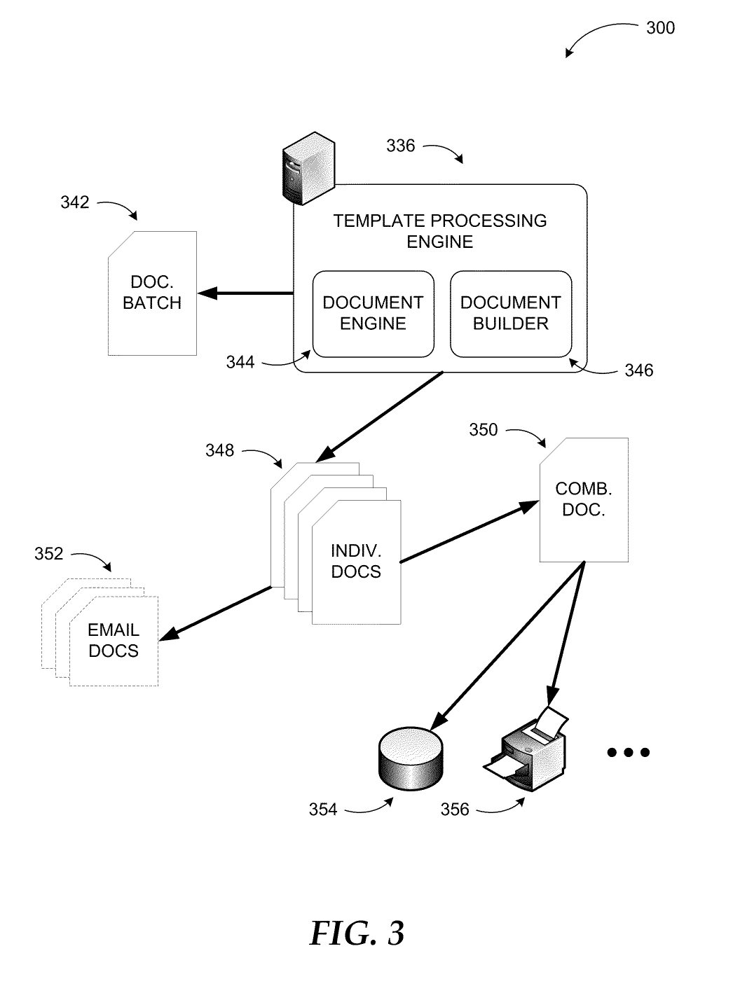

FIG. 3 includes block diagram 300 illustrating different components of a template processing engine according to embodiments in generating combination documents. As discussed above, template processing engine 336 may enable generation and/or modification of reports creating a report document. The tasks resulting in the report document may be performed by document engine 344. In addition, template processing engine 336 may also generate a combined report document 350 from a plurality of report documents 348 and perform tasks associated with the plurality of report documents 348 and/or the combined document 350. These tasks may be performed by document builder module 346.

Example tasks that may be performed by document builder module 346 include, but are not limited to, printing document batches 342, emailing or similarly transmitting the plurality of documents 352, storing the combined document 350 to a data store 354, or printing the combined document 350 through printing device 356.

While the example systems in FIGS. 1, 2, and 3 have been described with specific components such as document engine and document builder module, embodiments are not limited to business systems according to these example configurations. A business system employing a template processing engine may be implemented in configurations employing fewer or additional components and performing other tasks.

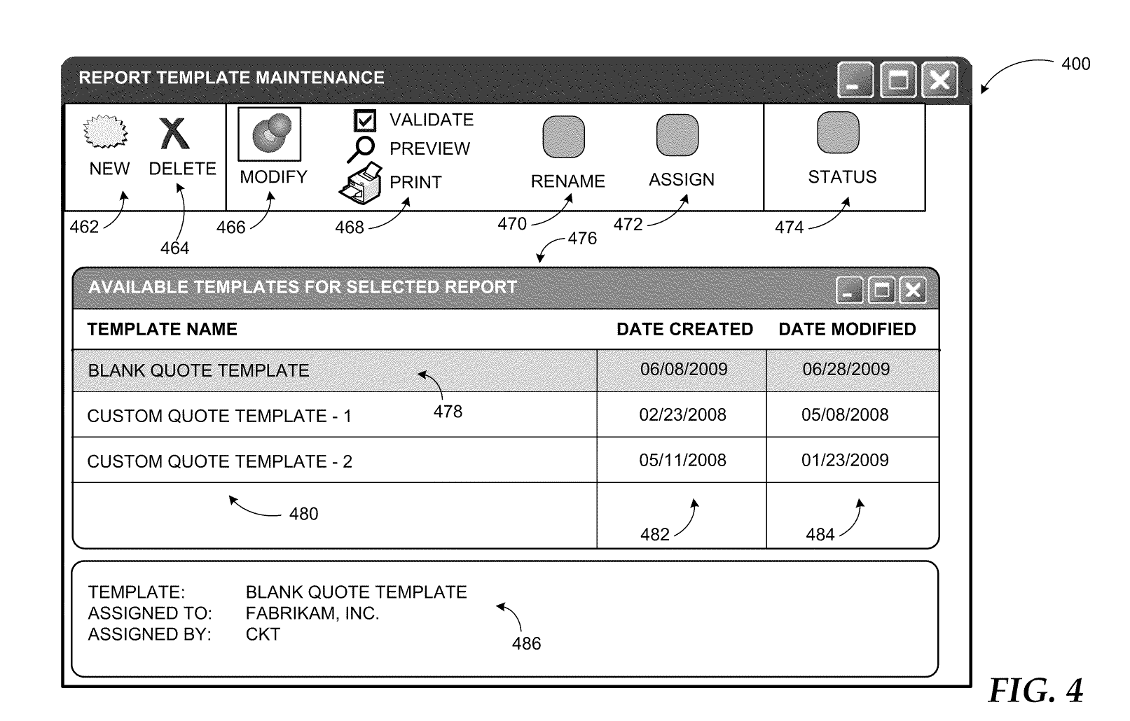

FIG. 4 is a screenshot of an example user interface 400 for generating/modifying report templates. User interface 400 is an example of a distinct user interface for template processing. As discussed previously, a user interface for a template processing engine according to embodiments may also be integrated into the user interface of an underlying business system.

User interface 400 includes a number of graphically/textually presented controls such as create new report 462, delete and existing report 464, modify an existing report 466, validate/preview/print a report 468, rename a report, 470, assign a report (e.g. to a user or organization) 472, and display the status of a report 474. These controls may be presented in a number of ways such as in a menu bar, as a hovering viewport, as an anchored viewport, and the like.

In another portion 476 of the user interface 400, available templates for a selected report may be presented as a list or in other formats. According to some embodiments, the available templates may be listed with their names (480), the creation dates (482), and their modification dates (484). Of course, other properties or labels of the available templates may also be displayed according to other embodiments. A selected template (478) may be distinguished from the others employing a textual, graphical, highlighting, coloring, shading, or similar scheme.

In yet another portion of the user interface 400, summary information 486 associated with the selected template (478) may be presented. In the example user interface, the summary information 486 includes template name, assigned organization, and assigning person's initials. Any additional information may be included in this portion based on default parameters and/or user preferences.

A user interface for a template processing engine according to embodiments may include fewer or additional components, may be configured differently, and provide more information. For example, the available templates may be provided in a collapsible tree format, further details on available templates may be provided, etc. Moreover, a template processing engine according to some embodiments may customize its user interface based on user credentials. For example, users with different permission levels may be allowed to see different information about available templates or select templates. Similarly, based on a user's credentials (e.g. their position in an organization), a subset of available templates may be displayed to enhance user experience.

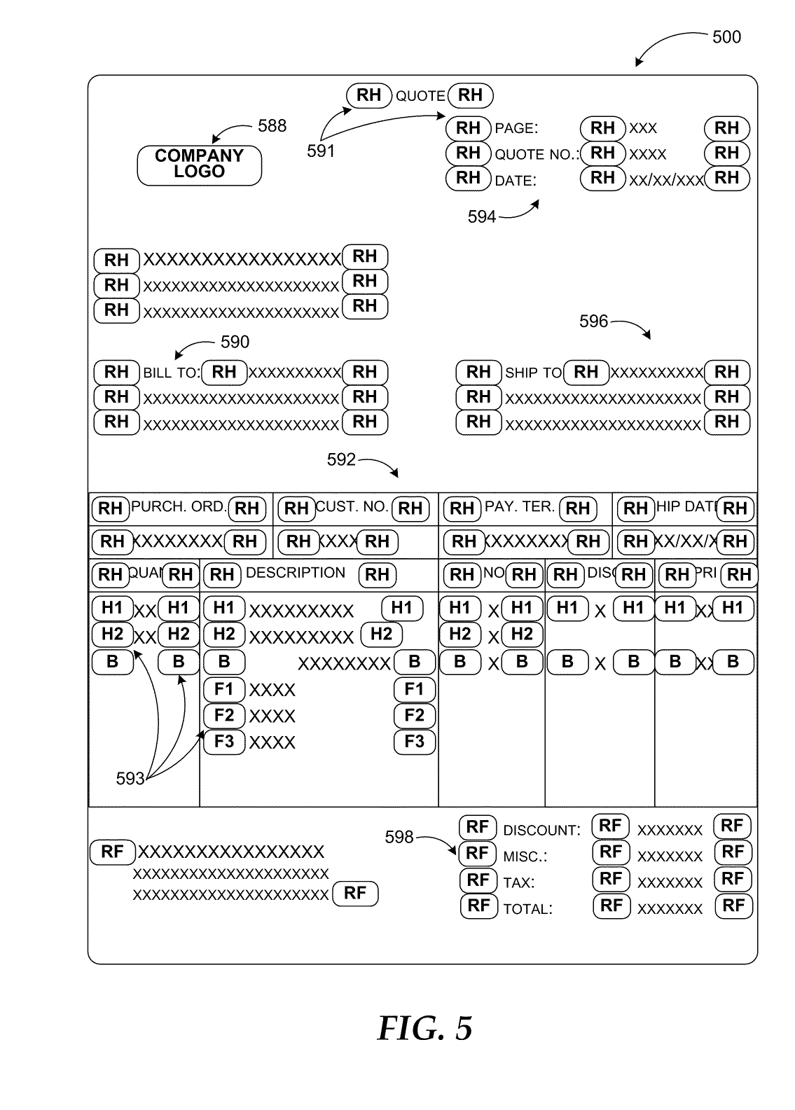

FIG. 5 is an example quote document with tags indicating different data segments that may be used by a template processing engine according to embodiments. The view of document 500 may also be referred to as design mode view.

In the design mode view, each content control tag and title may be defined by the custom structured part of the document. For example, in systems using Extensible Markup Language (XML), the custom XML part may be defined those tags. Each of the different data parts such as company logo 588, data defined by report header tags 591, and other types of tags 593 (e.g. header tags H1, H2; footer tags F1, F2, F3; body tag B, etc.) may be customized by the user. Non-repeating data may include sections such as “Quote”, “Purchase Order” etc. Repeating sections of data may have any number of differing rows, which correspond to multi-banded report writer sections. The rows in the repeating section may be identified as belonging to distinct categories identified by the tags as described above. The template processing engine reads data, clones the appropriate template row, and adds that row to the output report.

The example document 500 is for a quote and includes combinations of non-repeating and repeating data. Section 594 includes report identification information such as page number, quote number, and date, where data indicated as “xxx . . . ” may be retrieved from a data source. The format of the retrieved data may be automatically modified based on template default parameters or user preferences.

Sections 590 and 596 identify billing and shipping particulars in a similar combination to section 594. Section 592 includes particulars of the quote and repeating data organized in rows as described above. Discount, tax, total price, and similar information are provided in section 598 as indicated by the RF (Report Footer) tags. The tags are used to identify different data segments such that the template engine can retrieve and place structured (e.g. XML) data in the appropriate places. As discussed previously, non-repeating and repeating data may be reformatted based on template default parameters or user preferences. Furthermore, portions of the data (repeating or non-repeating) may be hidden or re-organized based on user credentials.

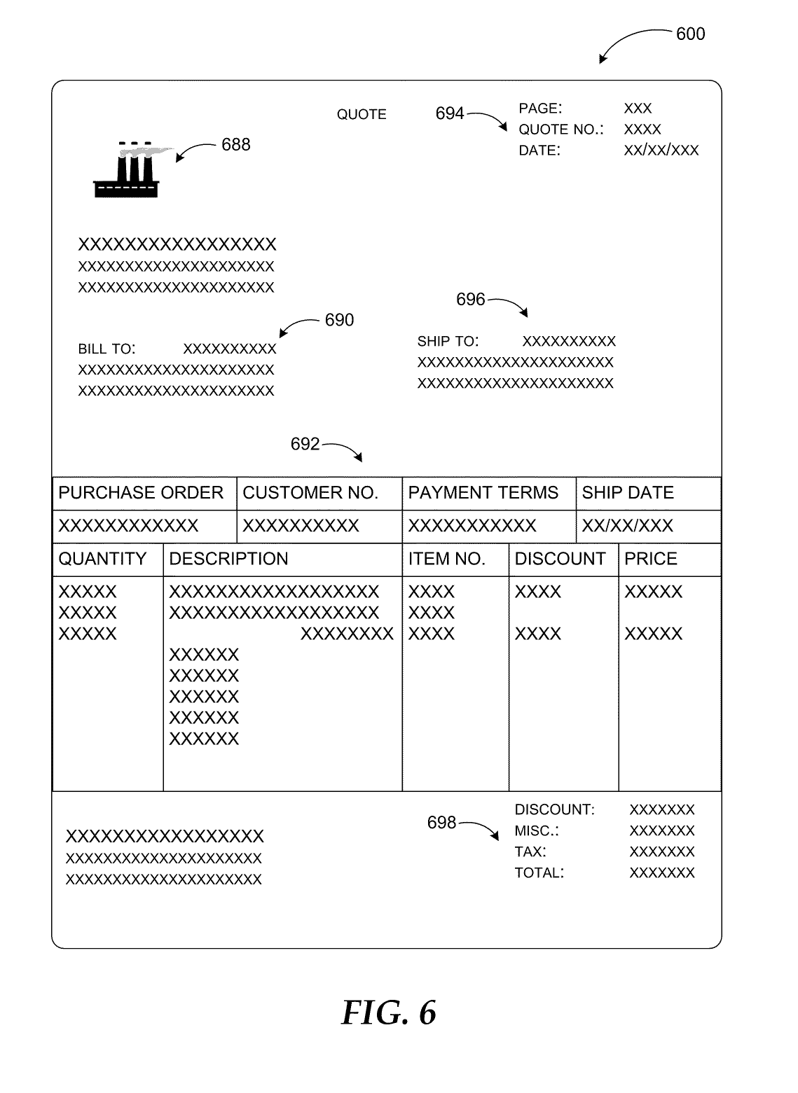

FIG. 6 is the example quote document of FIG. 5 after it has been processed by the template processing engine. Document 600 is in user view mode (the way the resulting document actually appears). Company logo 688 has been inserted based on the selected template, repeating and non-repeating data—as identified by their corresponding tags—have been reformatted, modified according to template parameters and user preferences, and inserted for sections 690, 692, 694, 696, and 698. An example of reformatting data is numbering. If the template engine determines the user credentials indicating that the user is working in Europe, the numbering scheme may be modified to European style (e.g. commas instead of periods or dd/mm/yyyy date instead of mm/dd/yyyy date).

While many components and configurations may be employed in generating or modifying reports with a template processing engine according to embodiments, example ones are described above for illustration purposes. The example reports, data configurations, and modes discussed herein are for example purposes, and do not constitute limitations on embodiments.

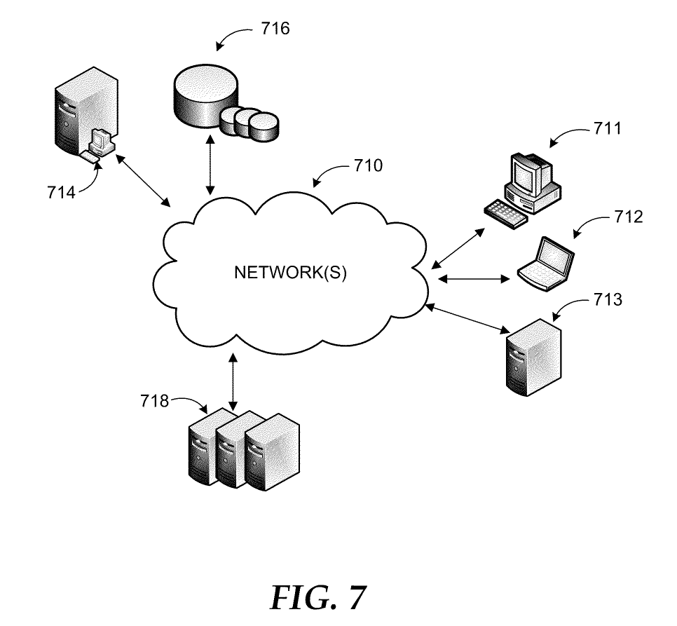

FIG. 7 is an example networked environment, where embodiments may be implemented. A platform providing template processing within business systems may be implemented via software executed over one or more servers 718 such as a hosted service. The platform may communicate with client applications on individual computing devices such as a server 713 or a laptop computer 712 and desktop computer 711 (‘client devices’) through network(s) 710.

As discussed above, a template processing engine may be used to generate and modify reports employing selectable templates and automatically processing data. A template processing service or application executed on servers 718 or single server 714 may receive input from users through client devices 711, 712 or server 713, retrieve templates and data from data store(s) 716, and provide the resulting report to the requesting user. In other embodiments, the resulting report may be transmitted (e.g. through email), printed, or stored based on user request.

Network(s) 710 may comprise any topology of servers, clients, Internet service providers, and communication media. A system according to embodiments may have a static or dynamic topology. Network(s) 710 may include secure networks such as an enterprise network, an unsecure network such as a wireless open network, or the Internet. Network(s) 710 may also coordinate communication over other networks such as Public Switched Telephone Network (PSTN) or cellular networks. Furthermore, network(s) 710 may include short range wireless networks such as Bluetooth or similar ones. Network(s) 710 provide communication between the nodes described herein. By way of example, and not limitation, network(s) 710 may include wireless media such as acoustic, RF, infrared and other wireless media.

Many other configurations of computing devices, applications, data sources, and data distribution systems may be employed to implement a business system with a template processing engine. Furthermore, the networked environments discussed in FIG. 7 are for illustration purposes only. Embodiments are not limited to the example applications, modules, or processes.

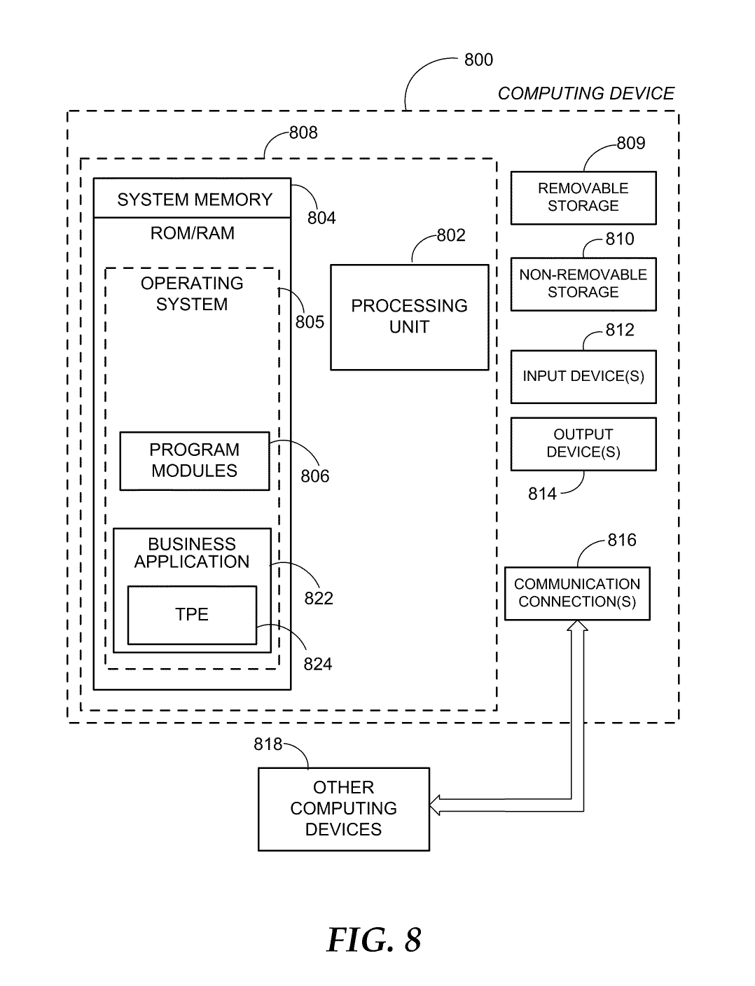

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as computing device 800. In a basic configuration, computing device 800 may be a server managing a business system and include at least one processing unit 802 and system memory 804. Computing device 800 may also include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of the platform, such as the WINDOWS® operating systems from MICROSOFT CORPORATION of Redmond, Wash. The system memory 804 may also include one or more software applications such as program modules 806, business application 822, and template processing engine 824.

Business application 822 may perform a wide range of business operations. Template processing engine 824 may be a module of business application 822 or a separate application and enable users to generate/modify custom reports from predefined templates and a wide range of data sources as discussed previously. This basic configuration is illustrated in FIG. 8 by those components within dashed line 808.

Computing device 800 may have additional features or functionality. For example, the computing device 800 may also include additional data storage devices (removable and/or non-removable) such as, for example, magnetic disks, optical disks, or tape. Such additional storage is illustrated in FIG. 8 by removable storage 809 and non-removable storage 810. Computer readable storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 800. Any such computer readable storage media may be part of computing device 800. Computing device 800 may also have input device(s) 812 such as keyboard, mouse, pen, voice input device, touch input device, and comparable input devices. Output device(s) 814 such as a display, speakers, printer, and other types of output devices may also be included. These devices are well known in the art and need not be discussed at length here.

Computing device 800 may also contain communication connections 816 that allow the device to communicate with other devices 818, such as over a wired or wireless network in a distributed computing environment, a satellite link, a cellular link, a short range network, and comparable mechanisms. Other devices 818 may include computer device(s) that execute communication applications, other directory or policy servers, and comparable devices. Communication connection(s) 816 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

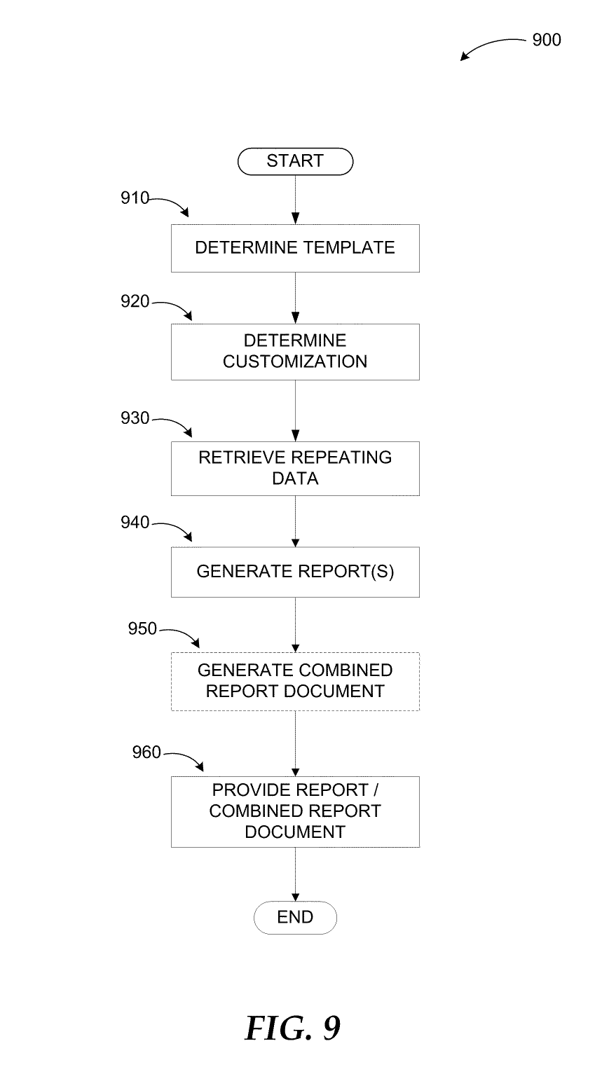

FIG. 9 illustrates a logic flow diagram for process 900 of generating reports using a template processing engine according to embodiments. Process 900 may be implemented as part of a business system that report generation as part multi-faceted business operations.

Process 900 begins with operation 910, where a template to be used by the template processing engine for generating a report is determined The template may be determined based on user input, user credentials, system parameters, and the like. Next, customization parameters for the selected template are determined at operation 920. Customization may include formatting of the report, formatting of data to be presented in the report, selection of portions of the report/data to be presented in the report, presentation mode, and comparable ones.

The data to be presented in the report (repeating data) is retrieved at operation 930. The data may be retrieved from a number of data sources such as relational databases, tables, structured data files (e.g. XML), or manually input by the user. This is followed by operation 940, where one or more reports are generated based on the selected template, customization parameters, and retrieved data. As discussed previously, portions of the report/data may be modified, hidden, etc. based on user preferences, system rules, and/or user credentials.

According to some embodiments, a combined document may be generated from multiple reports at optional operation 950. The individual report(s) and/or the combined document may then be provided as requested by the user at operation 960. This may entail displaying the report(s), printing them to a selected printing device, storing to designated data storage, transmitting to selected targets via email, etc., or similar operations.

The operations included in process 900 are for illustration purposes. Report generation and modification through a template processing engine may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for generating reports in a business system, the method comprising:
determining a template for a report at a processor;
determining customization parameters for the report;
retrieving repeating data for the report; and
generating the report based on the determined template and the customization parameters by processing at least one portion of the retrieved data according to the customization parameters.

2. The method of claim 1, wherein the template is determined based on at least one from a set of: a user selection, a user credential, and a system default rule.

3. The method of claim 1, wherein the customization parameters are determined based on at least one from a set of: a user selection, a user credential, and a system default rule.

4. The method of claim 1, wherein processing the at least one portion of the data includes at least one from a set of: re-organizing the retrieved data, modifying a format of the retrieved data, hiding a portion of the retrieved data, and modifying another portion of the retrieved data.

5. The method of claim 1, further comprising:
generating a combined report document from a plurality of reports.

6. The method of claim 5, further comprising:
providing one of the report and the combined report document through at least one from a set of: transmitting electronically to a user selected target, printing to a selected printing device, storing to a user selected data storage, and displaying on a display device.

7. The method of claim 5, wherein the report and the combined report document include one of: a word processing document, a spreadsheet document, and a presentation document.

8. The method of claim 1, wherein the repeating data is retrieved from one of: a user input, a relational database, a structured data source, and a table.

9. The method of claim 1, further comprising:
customizing and integrating the repeating data into the template at runtime.

10. The method of claim 1, further comprising:
enabling a user to provide input associated with template selection and customization parameters through one of: a user interface associated with a template processing engine and a user interface associated with the underlying business system.

11. The method of claim 10, wherein the report includes one of: a quote, an invoice, a sales analysis, an inventory analysis, and an order.

12. A system for generating reports in a business system, the system comprising:
a server executing a business application associated with the business system, the business application managing data associated with business operations; and
the server further executing a template processing engine, the template processing engine performing actions including:
determine a template for a report based on at least one from a set of: a user selection, a user credential, and a system default rule;
determine customization parameters for the report based on at least one from a set of: a user selection, a user credential, and a system default rule;
retrieve repeating data corresponding to multi-banded report sections;
clone appropriate template rows based on the retrieved data; and
generate an output report based on the determined template and the customization parameters by customizing and inserting the appropriate template rows to the output report.

13. The system of claim 12, wherein the template processing engine comprises a document engine for generating the output report and a document builder for:
generating a combined report document from a plurality of reports; and
providing the combined report document through at least one from a set of: transmitting electronically to a user selected target, printing to a selected printing device, storing to a user selected data storage, and displaying on a display device.

14. The system of claim 12, wherein the retrieved data is structured data and the customization is performed based on recognizing distinct sections of the report through identifying tags in the structured data.

15. The system of claim 12, wherein repeating and non-repeating data sections of the output report are customized based on at least one of: template default parameters and user preferences.

16. The system of claim 12, wherein the template processing engine is one of: a module of the business application, a separate application, a centralized service, and a distributed service.

17. A computer-readable storage medium with instructions stored thereon for generating reports in a business system through a template processing engine, the instructions comprising:
determining a template for a report based on at least one from a set of: a user selection, a user credential, and a system default rule;
determining customization parameters for repeating and non-repeating data sections of the report based on at least one from a set of: a user selection, a user credential, and a system default rule;
retrieving repeating data corresponding to multi-banded report sections;
cloning appropriate template rows based on the retrieved data;
generating an output report based on the determined template and the customization parameters by customizing and inserting the appropriate template rows to the output report;
generating a combined report document from a plurality of reports; and
providing one of the output report and the combined report document through at least one from a set of: transmitting electronically to a user selected target, printing to a selected printing device, storing to a user selected data storage, and displaying on a display device.

18. The computer-readable medium of claim 17, wherein the template processing engine provides a user interface that includes control elements for selection of the template and customization of the output report.

19. The computer-readable medium of claim 18, wherein the user interface employs at least one from a set of: a textual scheme, a graphical scheme, a shading scheme, a highlighting scheme, and a coloring scheme to distinguish the selected template and customized elements of the output report.

20. The computer-readable medium of claim 17, wherein the user interface is configured to display a design mode of the output report identifying the repeating and non-repeating data sections of the output report, and to display a view mode of the output report with customizations integrated into the output report.
